(19) United States
(12) Patent Application Publication
(10) Pub. No.: US 2019/0274339 A1
(43) Pub. Date: Sep. 12, 2019

(54) METHOD FOR MANUFACTURING COMPOSITION OF FERMENTED SOYBEAN PRODUCTS AND COMPOSITION OF FERMENTED SOYBEAN PRODUCTS MANUFACTURED THEREBY

(71) Applicant: CJ CHEILJEDANG CORPORATION, Seoul (KR)

(72) Inventors: Hyun Jun JANG, Yongin-si (KR); Hye Won SHIN, Seoul (KR); Sun A CHO, Suwon-si, Gyeonggi-do (KR); Chi Kwang SONG, Anyang-si, Gyeonggi-do (KR); Ha Na CHO, Suwon-si (KR); Sang Myung SHIN, Seoul (KR); Dae Seong YOON, Yeoju-si (KR); Eun Seok JANG, Suwon-si (KR)

(21) Appl. No.: 16/347,595

(22) PCT Filed: Nov. 16, 2017
(86) PCT No.: PCT/KR2017/013057

§ 371 Date: May 6, 2019

(30) Foreign Application Priority Data
Nov. 18, 2016 (KR) 10-2016-0154342
Nov. 16, 2017 (KR) 10-2017-0153461

(51) Int. Cl. A23L 11/30; A23L 11/00; A23L 3/36; A23L 3/005

(52) U.S. Cl. CPC A23L 11/31; A23L 11/07; A23V 2002/00; A23L 3/36; A23L 3/005; A23L 11/09

(57) ABSTRACT

Provided is a method for manufacturing a composition of fermented soybean products and a composition of fermented soybean products manufactured by the method.

### CROSS-REFERENCE TO RELATED APPLICATIONS

This application claims the benefit of Korean Patent Application No. 10-2015-0169172, filed on Nov. 30, 2015, in the Korean Intellectual Property Office, the disclosure of which is incorporated herein in its entirety by reference.

### TECHNICAL FIELD

The present disclosure relates to a method for manufacturing a composition of fermented soybean products and a composition manufactured by the method.

### BACKGROUND ART

For soybean paste products (e.g., soybean paste and hot pepper paste), which are consumed a lot by people in Korea, fermentation products are manufactured into fermented foods with excellent flavors and savory tastes from fermented products that are produced by decomposition of proteins and carbohydrates, etc. by an Aspergillus-derived enzyme and by microorganisms during fermentation. However, the presence of such an enzyme and microorganisms in the product is one of the major factors that can degrade the quality of the product during distribution. That is, excessive fermentation by microorganisms and decomposition of the components by the residual enzyme during distribution cause deterioration of quality such as gas generation and browning.

Additionally, naturally-occurring microorganisms proliferate during the fermentation process and these microorganisms may include harmful bacteria that harm human body via food poisoning, etc. Accordingly, commercially available soybean products are manufactured by sterilizing at 60° C. to 80° C. for 10 to 30 minutes or by adding a small amount of ethanol to minimize the quality deterioration during distribution and to sterilize harmful microorganisms. In particular, ethanol is a natural food preservative that has been used along with salt, etc. since the old times, and generally shows a strong inhibitory effect against Gram negative bacteria. Bacteria of the genus Bacillus or fungal spores are also inhibited by ethanol at high concentration. However, in high-salt fermented soybean products, the growth of microorganisms can be strongly inhibited even at a low concentration of ethanol, and thus, 2% to 3% of liquor is added to fermented soybean products.

However, in order to export to the Islamic market, it is necessary to reduce the level of microorganisms in the fermented soybean products where ethanol is not added, or low viscosity products manufactured using fermented soybean products (e.g., sauces, mixed soybean products, and marinates) or applied products thereof to ensure stable distribution at room temperature. It is also necessary to kill spores of Bacillus cereus, etc. that cause food poisoning, but it is difficult to achieve under the above sterilization conditions.

Accordingly, there is a need for the development of a sterilization method capable of killing harmful microorganisms and spores thereof without losing the quality of fermented soybean products, such as the flavor.

Additionally, with regard to sterilization of fermented soybean products, according to the national food standard, the standard level of Bacillus cereus for fermented soybean products and fermented soybean products-based sauces is below 10,000 CFU/g. To kill heat-resistant spore-producing bacteria (e.g., bacteria of the genus Bacillus), intermittent sterilization or sterilization at high temperature is required. However, commercial application of intermittent sterilization is difficult because it is time-consuming and is affected much by seasonal factors. In the case of high temperature sterilization, the contents are sealed and heated at a high temperature of 121° C. under high pressure for several minutes to several tens of minutes, which not only deteriorates sensory qualities (e.g., taste, appearance, texture, etc.), but also causes an overload the equipment due to changes in physical properties, and thus, there are many difficulties in securing safety and maintaining quality.

The method of food sterilization may be divided into two types, non-thermal sterilization and thermal sterilization based on the presence of heating. Non-thermal sterilization includes irradiation, ultra-high pressure sterilization, light pulse treatment, etc. The non-thermal sterilization can maintain freshness of nutrients and foods, and has the advantage of preventing the degradation of food flavor due to heat treatment, but it has a disadvantage in that the sterilization capability against microorganisms is reduced.

Thermal sterilization can be classified into high temperature sterilization and low temperature sterilization according to types of a microorganism of interest. High temperature sterilization is a method of reducing heat-resistant microorganisms at a temperature of 100° C. or higher, which includes instant sterilization, retort sterilization, etc., whereas low temperature sterilization is a method of reducing and sterilizing vegetative cells of heat-labile pathogenic microorganisms or yeast fungi, etc. at a temperature of 100° C. or lower, which includes batch sterilization, etc. Among these thermal sterilization methods, direct thermal sterilization (steam injection sterilization) is more economical and practical than other sterilization methods and is thus widely used in food industry.

Additionally, according to types of a sterilizer, food sterilization methods may be classified into a batch system sterilization (e.g., batch sterilization, retort sterilization), a continuous system sterilization (e.g., high-temperature short time (HTST), ultra-high temperature (UHT), pasteurization, etc.).

According to the structure of a heat exchanger, the high-temperature short time (HTST) method can be classified into a method using a plate-type heat exchanger (plate-type HTST) and a method using a tubular-type heat exchanger (tubular-type HTST). The heat exchanger is in the form of a dual body.

For example, Korean Patent Application Laid-open Publication No. 10-2000-0056729 discloses a method for manufacturing a sterilized liquid cooking sauce in which the sterilization is performed at a temperature of 130° C. to 150° C. using a continuous tubular-type sterilization apparatus for about 2 seconds to about 2 minutes and an apparatus thereof. However, the above sterilization apparatus has a difficulty in realizing the quality of fermented soybean products because the apparatus undergoes an increase in pressure and a decrease in heat transfer efficiency when applied to high viscosity products thus causing changes in taste quality by caramelization due to excessive thermal shock.

### PRIOR ART DOCUMENT

### Patent Document

(Patent Document 1) Korean Patent Application Laid-open Publication No. 10-2000-0056729 (Sep. 15, 2000)

### DISCLOSURE OF THE INVENTION

### Technical Problem

To solve the above problems, an object of the present disclosure is to provide a method for manufacturing a composition of fermented soybean products, which includes: preheating a raw material of the fermented soybean product; sterilizing the raw material using steam as a heating medium; and cooling, filling, and packing the sterilized raw material.

Additionally, another object of the present disclosure is to provide a composition of fermented soybean products manufactured by the above method.

### Technical Solution

To achieve the above objects, an aspect of the present disclosure provides a method for manufacturing a composition of fermented soybean products preheating a raw material of the fermented soybean product; sterilizing the raw material using steam as a heating medium; and cooling, filling, and packing the sterilized raw material.

The composition of fermented soybean products may be known fermented soybean products for which sterilization is required. Specifically, the composition may be any one selected from hot pepper paste (“Gochujang” in Korean), soybean paste (“Doenjang” in Korean), and a seasoned soybean paste (“Ssamjang” in Korean), or a mixture thereof, or a fermented-soybean-product-based sauce containing the same.

The hot pepper paste may contain water in an amount of 36-41 wt % and the soybean paste may contain water in an amount of 48-53 wt %. Additionally, the seasoned soybean paste may contain water in an amount of 44-48 wt % and the fermented-soybean-product-based sauce may contain water in an amount of 45-75 wt %. Meanwhile, the fermented-soybean-product-based sauce may be manufactured by mixing 50-60 wt % of soybean paste with 1-10 wt % of an anchovy/Laminaria japonica extract and 30-40 wt % of purified water.

The manufacturing method may further include a step for adding water to a composition of fermented soybean products before the step for preheating. In the step for adding water, at least one selected from a seasoning liquid (anchovy, Laminaria japonica, etc.), low sugar, mirim, liquor, etc. may be further added together with water. Although the manufacturing method undergoes a sterilization step through the step for adding water, the changes in quality can be minimized and thus the quality of the raw material can be maintained. Additionally, in a case where a sterilization facility requiring flowability of a subject for sterilization is used, for example, a direct steam injection heater is used, the overload of the facility can be prevented. Specifically, the addition of water can be achieved by adding water in an amount of 1-50 parts by weight, and more specifically 1-40 parts by weight relative to 100 parts by weight of the raw material.

For example, when the raw material of the fermented soybean products is hot pepper paste, the step for adding water to the fermented soybean products may be achieved by adding water in an amount of 1-20 parts by weight, and specifically 5-15 parts by weight relative to 100 parts by weight of the hot pepper paste, and water may be added so that the water content in the hot pepper paste can be in a range of 41-50 wt %, and more specifically 42-46 wt %. Additionally, when the raw material of the fermented soybean products is soybean paste, the step for adding water to the composition of fermented soybean products may be achieved by adding water in an amount of 3-18 parts by weight relative to 100 parts by weight of the soybean paste, and specifically, so that water may be added so that the water content in the soybean paste can be in a range of 54-60 wt %, and more specifically 54-56 wt %. Additionally, when the raw material of the fermented soybean products is seasoned soybean paste, the step for adding water to the composition of fermented soybean products may be achieved by adding water in an amount of 1-10 parts by weight relative to 100 parts by weight of the seasoned soybean paste, and specifically, so that water may be added so that the water content in the seasoned soybean paste can be in a range of 44-56 wt %, and more specifically 48-52 wt %. Additionally, when the raw material of the fermented soybean products is a soybean-product-based sauce, the step for adding water to the composition of fermented soybean products may be achieved by adding water in an amount of 1-40 parts by weight of an anchovy/Laminaria japonica extract and water relative to 100 parts by weight of the fermented-soybean-product-based sauce.

The manufacturing method of the present disclosure may further include a step for chopping a composition of fermented soybean products. The step for chopping may be included after the step for adding water. Through the chopping step, the raw material containing water can be further homogenized there increasing the efficiency of sterilization and an overload of facilities.

The step for preheating the composition of fermented soybean products of the present disclosure, by heating the raw material before sterilization using steam, has the effects of preventing quality deterioration due to rapid temperature change in the sterilization step, preventing slurry, and preventing the subsequent overload of the equipment. The preheating may be performed at different heating temperatures depending on the raw material or moisture content thereof. Specifically, the composition of fermented soybean products may be heated to 45° C. to 85° C., and more specifically 55° C. to 65° C.

The step for sterilizing the raw material may be to sterilize the raw material using steam as a heating medium. As the sterilization method using steam as a heating medium, a direct steam injection or indirect steam injection may be used. For example, as the sterilization using a direct steam injection, a direct steam injection heater (DSI) may be used, and as the sterilization using an in direct steam injection, a scraped-surface heat exchanger (SSHE) or a batch-type sterilization method may be used. The sterilization using a direct steam injection heater has a greater sterilization effect compared to the conventional methods for sterilizing fermented soybean products, and thus has an advantageous effect even when a long-term preservation of the fermented soybean products is required, as in a case where the fermented soybean products are to be exported.

The conventional method of sterilization of fermented soybean products was mainly relied on a batch-type sterilization, and in this method, sterilization is performed at about 65° C. to 70° C. for about 15-30 minutes. Such a batch-type sterilization had problems in that the sterilization effect was lowered, the ethanol of the raw material remained, or it was difficult to maintain the quality of the raw material (see Comparative Examples 1-3). However, since sterilization is performed using a direct steam injection heater in the present disclosure, it is possible to reduce the number of microorganisms to a level below the standard of domestic food standard while maintaining the quality of the food.

Additionally, the sterilization step may be performed at 105° C. to 135° C., and specifically 115° C. to 130° C., for 5-40 seconds, and specifically 10-35 seconds. When the sterilization step is performed outside of the above temperature range, the sterilization may not be performed or excessive sterilization may deteriorate the quality of the product. More specifically, the preheated hot pepper paste, seasoned soybean paste, or fermented-soybean-product-based sauce may be sterilized at 120° C. for 15-30 seconds, and for soybean paste, the sterilization may be performed at 120° C. to 125° C. for 30 seconds.

The sterilized raw material will have a low level of the total number of bacteria or common bacteria may not be detected, and Bacillus cereus and Clostridium perfringens are harmful microorganism that produce heat-resistant spores. Although it is difficult to reduce the total number of these microorganisms by general sterilization, the total number of these microorganisms can be reduced by the above sterilization step.

As used herein, the term “total number of bacteria” refers to the number of common bacteria. The fermented soybean products manufactured by the method of the present disclosure may have a total number of bacteria at a level of 10³ CFU/g or lower, specifically 10⁴ CFU/g or lower, and more specifically 10³ CFU/g or lower, or 0 CFU/g. For example, when the sterilization is performed at a temperature of 120° C. for 30 seconds, the total number of bacteria may be 10 CFU/g or lower or 0 CFU/g.

For example, the composition of fermented soybean products manufactured by the method of the present disclosure may have a log value of 0% to 70%, and specifically a log value of 0% to 55% relative to the total number of bacteria (CFU/g), a log value of 100%, of the composition of fermented soybean products before sterilization. The 0% may include that in which the total number of bacteria (CFU/g) of fermented soybean products manufactured after sterilization 0 CFU/g thus not being detected.

The total number of bacteria described above complies with the food standard specification of fermented soybean products and fermented-soybean-product-based sauces, and when the above range is met, there is an effect that microorganism are not proliferated at room temperature for a long-term period (3 months, 6 months, or 12 months or longer). Accordingly, when the above range is met, the detection standard of the total number of bacteria required for sauces in USA, Japan, etc. (i.e., 10³ CFU/g or less) can be met. Furthermore, the distribution of products and the safety of microorganisms can be ensured, and thus, it is highly likely that these products can be applicable to a Halal product. Additionally, therefore, the manufacturing method of the present disclosure is characterized in that the method manufactures a composition of fermented soybean products for distribution at room temperature (see Experimental Example 5).

Additionally, after the sterilization, the composition of fermented soybean products can reduce the alcohol odor by reducing the ethanol content relative to the raw material before sterilization, thereby improving the sensory properties of the composition of fermented soybean products. Specifically, the ethanol content of the composition of fermented soybean products after sterilization may be in an amount of 1 part by weight or less, 0.5 parts by weight or less, 0.1 parts by weight or less, 0.01 parts by weight or less and/or 0.001 parts by weight or more, 0.005 parts by weight or more, relative to 100 parts by weight of the composition of fermented soybean products (Experimental Example 3).

Additionally, the composition of fermented soybean products after sterilization may have a reduced salinity compared to the raw material before sterilization. Specifically, the salinity of the composition of fermented soybean products after sterilization may be 95% to 99.9%, and more specifically 97% to 99%, relative to 100% of the salinity of the raw material before sterilization. Conventionally, a process of increasing the salinity was used so as to increase the sterilization effect. However, since sterilization is performed using the direct steam injection in the present disclosure, the method exhibits a sufficient sterilization effect although the salinity of the composition of fermented soybean products may not be increased, and thus, the sensory properties of the manufactured composition of fermented soybean products can be improved.

The step for cooling, filling, and packing the sterilized raw material of the present disclosure is a step in which a sterilized raw material is cooled under reduced pressure, filled, and packaged to be manufactured into a product, and the fishy odor and the sterilization odor of the product can be reduced by the process of cooling under reduced pressure. Specifically, the sterilized raw material may be cooled to a temperature of 15° C. to 35° C. When the temperature is outside of the range, the quality of the product may be deteriorated. Additionally, the method of the present disclosure may not include a step for adding ethanol. As described above, the conventional method of manufacturing a composition of fermented soybean products includes the addition of ethanol for the effect of sterilization, the above method can exhibit a sufficient sterilization effect through sterilization by the direct steam injection (DSI) method, and the alcohol content in the manufactured composition of fermented soybean products is reduced and thus the alcohol odor is also reduced thereby being capable of improving the sensory properties of the composition of fermented soybean products.

The manufacturing method of the present disclosure has the effect of manufacturing a composition of fermented soybean products, in which the problem of a pressure increase during sterilization can be resolved by adding water to a raw material followed by chopping the same before sterilization, and thus the overload of a facility can be prevented; additionally, the heat transfer efficiency can be increased via a direct steam injection method, and thereby, enabling sterilization of the raw material to comply with the Korean Food Standard Regulations, while simultaneously maintaining the quality (e.g., color, flavor, texture, etc.) of the sterilized composition of fermented soybean products and reducing the odor by cooling under reduced pressure.

A second aspect of the present disclosure provides a composition of fermented soybean products manufactured by the above method. The composition of fermented soybean products manufactured by the above method is fermented soybean products, in which the quality of the conventional fermented soybean products is maintained and storage property is improved by using the direct steam injection method and the addition of water before heating, although the method undergoes sufficient sterilization. Since the composition of fermented soybean products manufactured by the above method includes the total number of bacteria, ethanol content, salinity, etc., these will not be described separately.

### Advantageous Effects

The manufacturing method of the present disclosure has the effects of maintaining the quality of conventional fermented soybean products by minimizing thermal impact being applied to products by using a direct steam injection method; providing an excellent flavor of fermented soybean products by removing the fishy odor of beans and the sterilization odor due to the deodorization function via cooling under reduced pressure; and simultaneously improving a preservation property by enabling stable distribution without the proliferation of microorganisms at room temperature due to a low number of microorganism in the product after sterilization.

Additionally, the color of the fermented soybean products is clear and bright, and the quality of the fermented soybean products is excellent by maintaining the physical properties or flowability, despite the addition of water or direct steam.

### BRIEF DESCRIPTION OF THE DRAWINGS

FIG. 1 shows the results of a total ion chromatogram, in which the flavor components of the hot pepper paste manufactured by Example 1 of the present disclosure and the hot pepper paste of Comparative Example 1 manufactured by the batch sterilization method are compared and analyzed.

### BEST MODE FOR CARRYING OUT THE INVENTION

Hereinafter, the present disclosure will be described in more detail through the Examples. However, the scope of the present disclosure is not limited to the Examples.

### EXAMPLES

### Example 1: Manufacturing of Fermented Soybean Products

To confirm the changes in quality and manufacturing effects of the sterilization method of the present disclosure, fermented soybean products were manufactured using hot pepper paste, soybean paste, seasoned soybean paste, and fermented-soybean-product-based sauces as raw materials. Specifically, in the step for adding water, for hot pepper paste, 5-15 parts by weight of purified water was added relative to 100 parts by weight of hot pepper paste; and for soybean paste, 2-10 parts by weight of purified water was added relative to 100 parts by weight of soybean paste; and for seasoned soybean paste, 1-10 parts by weight of purified water was added relative to 100 parts by weight of seasoned soybean paste. The fermented-soybean-product-based sauce was manufactured by mixing 50-60 wt % of soybean paste with 1-10% of an anchovy/Laminaria japonica extract and 30-40% of purified water. The fermented soybean products in which water was added were chopped into a size of 1-3 mm and preheated to 60° C., and then sterilization was performed using a direct steam injection heater (DSI) at 110° C. to 125° C. for 15-35 seconds. Additionally, the resultant was cooled under reduced pressure and filled/packaged to manufacture fermented soybean products.

### Comparative Example 1: Confirmation of Sterilization Effect on Fermented Soybean Products According to Batch Sterilization Method

To confirm the effect of sterilization of fermented soybean products using the conventional sterilization method, the sterilization was performed using the conventional batch sterilization method for fermented soybean products. After the sterilization, the number of common bacteria, heat-resistant bacteria, Bacillus cereus, fungi, and Salmonella were confirmed and the results are shown in Table 1 below. The specific sterilization conditions were as follows: for hot pepper paste, at 65° C. for about 15 minutes; for soybean paste, at 75° C. for about 20 minutes; and for seasoned soybean paste, at 72° C. for about 20 minutes. In Table 1 below, the unit is CFU/g and % represents relative value of bacteria number (% log), and specifically, % log represents a percentage of the log value of the number of bacteria relative to the log value of the number of bacteria before sterilization. Additionally, “nd” (which represents “not detected”) was assumed that the log value is 0.

TABLE 1
Results of analysis of microorganisms according to batch-
type sterilization treatment of fermented soybean products

| | Hot Pepper Paste | | Soybean Paste | | Seasoned soybean paste | |
|---|---|---|---|---|---|---|
| | (CFU/g) | | (CFU/g) | | (CFU/g) | |
| | Before | After | Before | After | Before | After |
| | Sterilization | Sterilization | Sterilization | Sterilization | Sterilization | Sterilization |
| Item | (%) | (%) | (%) | (%) | (%) | (%) |
| Common | 6.9 × 10⁶ | 1.4 × 10⁶ | 4.7 × 10⁸ | 4.3 × 10⁸ | 5.4 × 10⁶ | 6.9 × 10⁵ |
| Bacteria | (100%) | (90%) | (100%) | (100%) | (100%) | (87%) |
| Heat- | 7.1 × 10⁶ | 1.2 × 10⁵ | 7.1 × 10⁶ | 4.8 × 10⁶ | 3.4 × 10⁵ | 1.8 × 10⁵ |
| Resistant | (100%) | (74%) | (100%) | (98%) | (100%) | (95%) |
| Bacteria | | | | | | |
| E. coli | Negative | Negative | Negative | Negative | Negative | Negative |
| B.C* | 7.0 × 10¹ | 5.0 × 10¹ | 2.8 × 10² | 2.6 × 10² | 1.0 × 10² | 8.0 × 10¹ |
| | (100%) | (92%) | (100%) | (99%) | (100%) | (95%) |
| Fungi | 7.8 × 10² | nd** | 1.8 × 10⁶ | 2.8 × 10¹ | 5.8 × 10⁵ | 1.0 × 10¹ |
| | (100%) | (0%) | (100%) | (23%) | (100%) | (17%) |
| Salmonella | Negative | Negative | Negative | Negative | Negative | Negative |

*B.C: Bacillus cereus
**nd: not detected

As a result of sterilization, the decrease of the number of fungi, which is the cause of swelling, was confirmed. However, it was confirmed that the cell death of common bacteria, heat-resistance bacteria, and Bacillus cereus was difficult under the sterilization conditions for batch-type method for commercially available fermented soybean products.

### Comparative Example 2: Confirmation of Sterilization Effect on Hot Pepper Paste According to Non-Thermal Sterilization (Ultrahigh Pressure)

To confirm the effect of sterilization on hot pepper paste according to ultrahigh pressure, the hot pepper paste was treated at 200-600 Mpa for 15-25 minutes, and then the numbers of common bacteria, yeasts, and fungi were counted. The results are shown in Table 2 below.

TABLE 2
Confirmation of sterilization effect according to
non-thermal sterilization (ultrahigh pressure)

| Conditions for | | | | |
|---|---|---|---|---|
| Treatment | | Microorganism (CFU/g) | | |
| Pressure | | Common | | |
| (Mpa) | Time (min) | Bacteria | Yeast | Fungi |
| 0 | 0 | 2.6 × 10⁵ | 8.0 × 10⁵ | 7.0 × 10³ |
| 200 | 15 | 1.2 × 10⁶ | 2.0 × 10⁵ | 5.0 × 10³ |
| | 25 | 5.0 × 10⁵ | 1.8 × 10⁵ | 2.4 × 10² |
| 400 | 15 | 3.0 × 10⁵ | 2.1 × 10⁴ | 2.0 × 10³ |
| | 25 | 1.6 × 10⁵ | 1.7 × 10⁴ | 2.1 × 10² |
| 600 | 15 | 1.1 × 10⁵ | 2.0 × 10³ | 7.0 × 10¹ |
| | 25 | 9.7 × 10⁴ | 3.0 × 10³ | 2.0 × 10¹ |

When treated at 600 Mpa for 25 minutes, the numbers of yeast and fungi tended to decrease by about 2 log, but it was confirmed that there was no effect of decreasing the number of common bacteria.

### Comparative Example 3: Confirmation of Sterilization Effect on Hot Pepper Paste According to Thermal Sterilization

To confirm the sterilization effect on hot pepper paste by a batch sterilizer and a retort sterilizer according to sterilization temperature, the hot pepper paste was sterilized at 90° C. to 121° C. for about 2-20 minutes and then the numbers of common bacteria and heat-resistant bacteria were confirmed. The results are shown in Table 3 below.

TABLE 3
Sterilization effect of thermal sterilization on hot
pepper paste

| Sterilization Condition | | | Microorganism (CFU/g) | |
|---|---|---|---|---|
| Sterilization | Temperature | | Common | Heat-Resistant |
| Facility | (° C.) | Time (min) | Bacteria | Bacteria |
| Batch | 0 | 0 | 1.2 × 10⁶ | 2.5 × 10³ |
| | 90 | 2 | 1.8 × 10⁵ | 2.3 × 10³ |
| | | 5 | 1.9 × 10⁵ | 9.0 × 10² |
| | 100 | 2 | 2.3 × 10⁴ | 1.8 × 10² |
| | | 5 | 6.0 × 10³ | 4.0 × 10¹ |
| | 105 | 2 | 8.0 × 10³ | 1.1 × 10² |
| Retort | 0 | 0 | 8.4 × 10⁶ | 9.6 × 10³ |
| (Autoclave) | 105 | 10 | 2.9 × 10⁶ | 6.4 × 10³ |
| | | 20 | 5.9 × 10⁵ | 3.7 × 10³ |
| | 115 | 5 | 2.1 × 10⁴ | 3.5 × 10² |
| | 121 | 5 | nd* | nd |

*nd: not detected

When the conventional batch sterilizer was used, the effect of reducing the number of bacteria was observed at 100° C. for 5 minutes and at 105° C. for 2 minutes. Specifically, the number of the common bacteria treated at 100° C. for 5 minutes and at 105° C. for 2 minutes was reduced by 3 log, respectively, and the number of the heat-resistant bacteria was reduced by 2 log and 1 log, respectively. However, it was confirmed that the color of the hot pepper paste became darker after sterilization.

When sterilized by the retort method, it was confirmed that the effect of reducing the number of bacteria was lower than the conventional batch, due to the decrease of heat transfer efficiency, whereas in a case of the hot pepper paste, which was sterilized at 121° C. for 5 minutes, the color became darker and the odor of carbonization was generated thus deteriorating the quality.

### Experimental Example 1: Measurement of Water Content in Hot Pepper Paste, Soybean Paste, and Seasoned Soybean Paste

The water content of the raw material (fermented soybean products) before water addition was measured by ambient pressure drying. Specifically, the fermented soybean products was dried by heating at 105° C. to 110° C. until the sample of fermented soybean products reached a constant weight, and the water content was quantified as a decrease of weight. The results of the measurement were as follows: hot pepper paste contained 39.4 wt % of water, soybean paste contained 48.9 wt % of water, and seasoned soybean paste contained 46.8 wt % of water.

### Experimental Example 2: Analysis of Volatile Flavor Components of Hot Pepper Paste Manufactured by the Method of the Present Disclosure

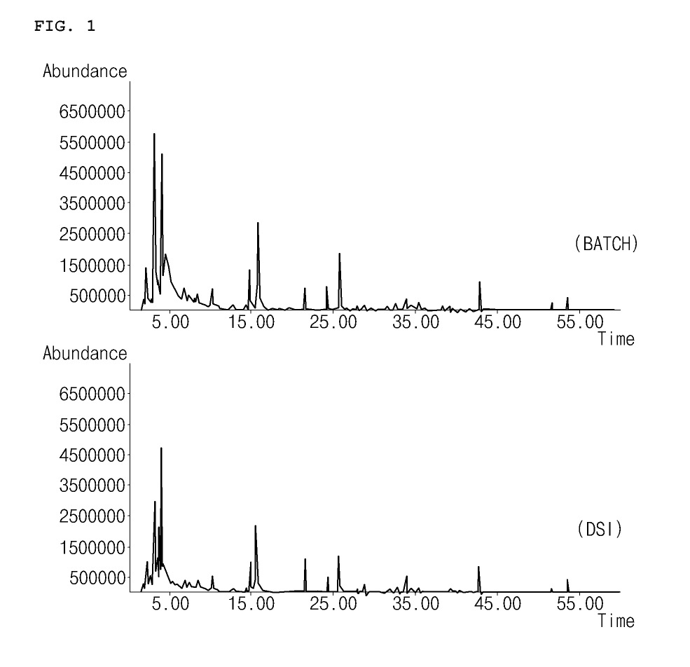

The volatile flavor components in the hot pepper paste manufactured by the direct steam injection sterilization method of Example 1 and the hot pepper paste manufactured by the batch sterilization method of Comparative Example 1 were analyzed and the results of comparison are shown in FIG. 1.

In both the product by the direct steam injection sterilization and the product by the batch sterilization method, ethanol accounted for the majority of alcohols, followed by 3-methyl-1-butanol and 2-methyl-1-butanol in this order. In particular, 1-hexanol and 1-octen-3-ol, which are flavor materials known to be involved in the representative soybean odor, were detected only in the hot pepper paste by the batch sterilization method, whereas 2-methylbutanal and 3-methylbutanal, which, being intermediate products of the Maillard reaction, are produced by the Strecker aldehyde Maillard reaction, are components which have malty, cocoa, and roasty flavors and play a positive role in the hot pepper paste, and showed a relatively high proportion in the DSI sterilized hot pepper paste. From these results, it was confirmed that the DSI sterilization and cooling under reduced pressure methods have a positive influence on the flavors of the hot pepper paste.

### Experimental Example 3: Analysis of Ethanol Content of Hot Pepper Paste Manufactured by the Method of the Present Disclosure

The ethanol contents of the hot pepper paste manufactured by the direct steam injection sterilization method of Example 1 and the hot pepper paste manufactured by the batch sterilization method of Comparative Example 1 were analyzed and the results of comparison are shown in Table 4 below. The ethanol content of the hot pepper paste before sterilization in which no liquor was added was 1.44%, and the ethanol content after the conventional batch sterilization method after sterilization was 1.39% thus showing no significant difference. Accordingly, it was confirmed that the hot pepper paste not only can improve sensory properties according to the alcohol odor, but also can be applied to a Halal product, with 0% alcohol content, thus having excellent marketability in the Islamic market.

TABLE 4
Results of analysis of components

| | | | Direct Steam Injection | |
|---|---|---|---|---|
| | Batch | | Sterilization | |
| | Before | After | Before | After |
| Item | Sterilization | Sterilization | Sterilization | Sterilization |
| Ethanol (%) | 1.44 | 1.39 | 1.44 | 0.00 |
| Water | 45.65 | 43.57 | 45.65 | 45.89 |
| Content (%) | | | | |
| Salinity (%) | 6.98 | 7.31 | 6.98 | 6.87 |
| pH | 4.37 | 4.42 | 4.37 | 4.44 |
| Aw | 0.8180 | 0.8113 | 0.8180 | 0.8322 |

### Experimental Example 4: Comparison of Products of Hot Pepper Paste and Soybean Paste Manufactured by the Method of the Present Disclosure, after Sterilization

To confirm the changes in quality of the fermented soybean products manufactured by the method of the present disclosure, 5 and 10 parts by weight of purified water was added to the hot pepper paste, and 4 and 8 parts by weight of purified water was added to the soybean paste, respectively, preheated to 60° C., and sterilized at 120° C. to 125° C. for 15-30 seconds by the direct steam injection sterilization method, and the physical properties and the chrominance of the fermented soybean products cooled under reduced pressure were compared. Specifically, the physical properties were examined by a texture analyzer and the chrominance was measured using a color difference meter. The results are shown in Table 5, and the L value of chrominance represents lightness, a value represents redness, and b value represents yellowness.

TABLE 5
Results of analysis of physical properties and chrominance

| | | Physical | | | | |
|---|---|---|---|---|---|---|
| | | Properties (g) | | | | |
| | | High | Low | Chrominance | | |
| Category | | Force | Force | L | a | b |
| Hot | Conventional | 71.6 | −40.1 | 22.8 | 12.7 | 5.0 |
| Pepper | (65° C./15 Min, | | | | | |
| Paste | Batch) | | | | | |
| | Addition of | 174.2 | −86.5 | 23.7 | 12.4 | 4.8 |
| | Purified Water × | | | | | |
| | (120° C./15 Sec, | | | | | |
| | DSI) | | | | | |
| | Addition of 5 | 87.1 | −43.9 | 24.3 | 11.4 | 6.3 |
| | Parts by weight | | | | | |
| | of Purified | | | | | |
| | Water | | | | | |
| | (120° C./15 Sec, | | | | | |
| | DSI) | | | | | |
| | Addition of 5 | 68.6 | −34.4 | 24.9 | 11.8 | 7.2 |
| | Parts by weight | | | | | |
| | of Purified | | | | | |
| | Water (120° C./15 | | | | | |
| | Sec, DSI) | | | | | |
| Soybean | Conventional | 145.7 | −78.2 | 45.7 | 5.8 | 16.1 |
| Paste | (75° C./20 Min, | | | | | |
| | Batch) | | | | | |
| | Addition of | 377.3 | −124.7 | 48.9 | 5.9 | 16.5 |
| | Purified Water × | | | | | |
| | (120° C./15 Sec, | | | | | |
| | DSI) | | | | | |
| | Addition of 4 | 208.1 | −104.3 | 49.4 | 6.2 | 16.7 |
| | Parts by weight | | | | | |
| | of Purified | | | | | |
| | Water | | | | | |
| | (120° C./15 Sec, | | | | | |
| | DSI) | | | | | |
| | Addition of 8 | 134.9 | −65.2 | 50.7 | 5.8 | 18.5 |
| | Parts by weight | | | | | |
| | of Purified | | | | | |
| | Water (120° C./15 | | | | | |
| | Sec, DSI) | | | | | |

In cases where both the physical properties of the hot pepper paste and the soybean paste were adjusted by adding purified water thereto, it was confirmed that the quality was improved even after the sterilization. Specifically, it was confirmed that the intrinsic physical properties were maintained in a case where 10 parts by weight of purified water was added to the hot pepper paste and in a case where 8 parts by weight of purified water was added to the soybean paste. This confirms that the method maintains color and quality and provides an excellent sterilization method to be described later, compared to the conventionally-used sterilization method used.

### Experimental Example 5: Confirmation of Sterilization Effect of Hot Pepper Paste and Soybean Paste Manufactured by the Method of the Present Disclosure

To confirm the sterilization effect of the present disclosure, hot pepper paste was manufactured by adding 5-15 parts by weight of purified water to 100 parts by weight of the hot pepper paste; soybean paste was manufactured by adding 2-10 parts by weight of purified water with respect to 100 parts by weight of the soybean paste; seasoned soybean paste was manufactured by adding 1-10 parts by weight of purified water to 100 parts by weight of the seasoned soybean paste; and a fermented-soybean-product-based sauce was manufactured by mixing 50-60% of soybean paste, 1-10% of an anchovy/Laminaria japonica extract and 30-40% of purified water. The mixed fermented soybean products were chopped into a size of 1-3 mm, put into a preheating tank and preheated to 55° C. to 65° C., sterilized by the DSI method, and cooled under reduced pressure. For the sterilized products, the total numbers of common bacteria, heat-resistant bacteria, Bacillus cereus, and fungi were confirmed, and the results are shown in Table 6. In Table 6 below, the unit is CFU/g and % represents relative value of bacteria number (% log), and specifically, % log represents a percentage of the log value of the number of bacteria relative to the log value of the number of non-sterilized bacteria (0, sterilization for 0 second). Additionally, “nd” (which represents “not detected”) was assumed that the log value is 0.

TABLE 6
Confirmation of sterilization effect

| | | | Microorganism (CFU/g) | | | |
|---|---|---|---|---|---|---|
| | Sterilization | | | Heat- | | |
| | Condition (DSI) | | Common | Resistant | | |
| | Temperature | Time | Bacteria | Bacteria | | |
| Category | (° C.) | (sec) | (%) | (%) | BC*(%) | Fungi(%) |
| Hot pepper | 0 | 0 | 4.8 × 10⁷ | 2.4 × 10⁵ | 1.6 × 10¹ | 6.2 × 10³ |
| paste | | | (100%) | (100%) | (100%) | (100%) |
| | 110 | 15 | 5.2 × 10⁴ | 1.8 × 10³ | nd**(0%) | nd(0%) |
| | | | (61%) | (61%) | | |
| | 115 | 15 | 1.4 × 10³ | 1.3 × 10¹ | nd | nd |
| | | | (41%) | (21%) | | |
| | 120 | 15 | 1.0 × 10¹ | nd (0%) | nd | nd |
| | | | (13%) | | | |
| | 120 | 30 | nd (0%) | nd | nd | nd |
| | 125 | 15 | nd | nd | nd | nd |
| Soybean | 0 | 0 | 2.7 × 10⁸ | 2.1 × 10⁶ | 1.8 × 10² | 1.0 × 10¹ |
| paste | | | (100%) | (100%) | (100%) | (100%) |
| | 115 | 15 | 3.6 × 10⁴ | 1.3 × 10¹ | nd(0%) | nd(0%) |
| | | | (54%) | (18%) | | |
| | 115 | 30 | 5.5 × 10³ | 3.1 × 10² | nd | nd |
| | | | (44%) | (39%) | | |
| | 120 | 30 | 2.5 × 10² | 2.0 × 10¹ | nd | nd |
| | | | (28%) | (21%) | | |
| | 125 | 30 | nd(0%) | nd(0%) | nd | nd |
| | 130 | 15 | nd | nd | nd | nd |
| Seasoned | 0 | 0 | 4.2 × 10⁶ | 3.7 × 10⁵ | 8.7 × 10² | 3.9 × 10² |
| soybean | | | (100%) | (100%) | (100%) | (100%) |
| paste | 110 | 15 | 6.6 × 10³ | 2.3 × 10¹ | nd(0%) | nd(0%) |
| | | | (58%) | (24%) | | |
| | 115 | 15 | 2.2 × 10³ | 1.5 × 10¹ | nd | nd |
| | | | (50%) | (21%) | | |
| | 120 | 15 | 6.0 × 10¹ | nd(0%) | nd | nd |
| | | | (27%) | | | |
| | 120 | 30 | nd(0%) | nd | nd | nd |
| | 125 | 15 | nd | nd | nd | nd |
| Fermented- | 0 | 0 | 6.1 × 10⁸ | 3.4 × 10⁵ | 5.1 × 10³ | 2.0 × 10¹ |
| Soybean- | | | (100%) | (100%) | (100%) | (100%) |
| Product- | 115 | 15 | 1.2 × 10⁴ | 3.3 × 10³ | nd(0%) | nd(0%) |
| based Sauce | | | (46%) | (64%) | | |
| | 115 | 30 | 2.5 × 10³ | 2.9 × 10² | nd | nd |
| | | | (39%) | (45%) | | |
| | 120 | 15 | 2.3 × 10² | 1.8 × 10¹ | nd | nd |
| | | | (27%) | (23%) | | |
| | 120 | 30 | 1.7 × 10² | 1.0 × 10¹ | nd | nd |
| | | | (25%) | (18%) | | |
| | 125 | 15 | nd(0%) | nd(0%) | nd | nd |

*BC: Bacillus cereus
**nd: not detected

When sterilization was performed by the method of the present disclosure, the total number of bacteria was confirmed to be less than 10³ CFU/g under the following conditions: for hot pepper paste, 15 seconds at 120° C.; for soybean paste, 30 seconds at 120° C. to 125° C.; for seasoned soybean paste, 15 seconds at 120° C.; and for a fermented-soybean-product-based sauce, 15 seconds or more at 120° C., and thereby confirmed that foreign standards were met.

Additionally, it was confirmed that microorganisms did not proliferate in the fermented soybean products manufactured by the method of the present disclosure even after the storage at 25° C. or 35° C. for 12 months.

### Experimental Example 6: Evaluation of Storage Property of Hot Pepper Paste Manufactured by the Method of the Present Disclosure

The microorganism present in the hot pepper paste manufactured by the direct steam injection sterilization method of Example 1 and the hot pepper paste manufactured by the batch sterilization method of Comparative Example 1, during storage, were analyzed and the comparison results are shown in Table 7 below. In a case of the hot pepper paste sterilized by the conventional batch sterilization method showed a tendency that yeast started to proliferate from the 4th week after storage and the swelling of the product was observed. Meanwhile, in a case of the hot pepper paste sterilized by the direct steam injection sterilization, none of the microorganism analyzed up to the 24th week after storage did not proliferate and also the swelling of the product was not observed thus confirming the stability of microorganisms in room temperature distribution with 0% ethanol content.

TABLE 7
Results of microorganisms in hot pepper paste manufactured
by the method of the present disclosure during storage

| | | | | | Heat- | | | | |
|---|---|---|---|---|---|---|---|---|---|
| | Storage | Storage | | Common | Resistant | | | | |
| Category | Temperature | Period | | Bacteria | Bacteria | BC | CP | Yeast | Remark |
| Batch | 25° C. | Week | 0 | 2*10⁵ | 2.4*10³ | 5*10¹ | ND | ND | Yeast |
| | | Week | 4 | 4*10⁵ | 2.5*10³ | ND | ND | 7*10³ | proliferation |
| | | Week | 8 | 7*10⁵ | 5.6*10³ | ND | ND | 10⁵ or | and swelling |
| | | | | | | | | greater | at week 4 |
| | 35° C. | Week | 0 | 2*10⁵ | 2.4*10³ | 5*10¹ | ND | ND | |
| | | Week | 4 | 3*10⁵ | 1.6*10³ | ND | ND | 9*10³ | |
| | | Week | 8 | 5*10⁵ | 1.8*10³ | ND | ND | 3.4*10⁴ | |

| | | | | | | | | |
|---|---|---|---|---|---|---|---|---|
| DSI | 25° C. | 0 | 30 | ND | ND | ND | ND | No proliferation |

| | | | | | | | |
|---|---|---|---|---|---|---|---|
| Week | 14 | 30 | ND | ND | ND | ND | and no swelling |
| Week | 18 | 30 | ND | ND | ND | ND | |
| Week | 24 | 90 | ND | ND | ND | ND | |

| | | | | | | |
|---|---|---|---|---|---|---|
| 35° C. | 0 | 30 | ND | ND | ND | ND |

| | | | | | | |
|---|---|---|---|---|---|---|
| Week | 14 | 30 | ND | ND | ND | ND |
| Week | 18 | 50 | ND | ND | ND | ND |
| Week | 24 | 90 | ND | ND | ND | ND |

# Package condition: unit weight 500 g/Packaging material: PP/No application of deoxidizing material

### Experimental Example 7 Results of Sensory Evaluation of Fermented Soybean Products Manufactured by the Method of the Present Disclosure (1)

To evaluate the quality of the hot pepper paste, soybean paste, seasoned soybean paste, and a fermented-soybean-product-based sauce of Experimental Example 6, which met the condition that the total number of bacteria after sterilization is 10³ CFU/g or less, 10 professional panelists were allowed to taste these products, and then a sensory evaluation was performed using a 5-point scale method to obtain the mean values. The results are shown in Table 8 below.

TABLE 8
Results of sensory evaluation of fermented soybean products
manufactured by the method of the present disclosure

| | Conditions | | | | | |
|---|---|---|---|---|---|---|
| | for Direct | | | | | |
| | Steam | Over- | | | | Steril- |
| Group of | Injection | all | | | | ization |
| Products | Sterilization | Taste | Color | Flavor | Taste | Odor |
| Hot Pepper | 115° C., 15 Sec | 3.85 | 3.78 | 3.88 | 3.87 | 3.81 |
| Paste | 120° C., 15 Sec | 3.85 | 3.91 | 3.84 | 3.84 | 3.77 |
| | 120° C., 30 Sec | 3.84 | 3.94 | 3.82 | 3.85 | 3.71 |
| | 125° C., 15 Sec | 3.80 | 3.85 | 3.75 | 3.79 | 3.58 |
| Soybean | 115° C., 30 Sec | 3.69 | 3.51 | 3.55 | 3.76 | 3.62 |
| Paste | 120° C., 30 Sec | 3.73 | 3.61 | 3.52 | 3.78 | 3.57 |
| | 125° C., 30 Sec | 3.72 | 3.59 | 3.50 | 3.75 | 3.54 |
| | 130° C., 15 Sec | 3.56 | 3.53 | 3.46 | 3.65 | 3.47 |
| Seasoned | 115° C., 15 Sec | 3.83 | 3.84 | 3.62 | 3.74 | 3.82 |
| soybean | 120° C., 15 Sec | 3.86 | 3.81 | 3.76 | 3.95 | 3.80 |
| paste | 120° C., 30 Sec | 3.82 | 3.77 | 3.70 | 3.92 | 3.76 |
| | 125° C., 15 Sec | 3.71 | 3.68 | 3.65 | 3.83 | 3.72 |
| Fermented- | 115° C., 30 Sec | 3.86 | 3.77 | 3.83 | 3.91 | 4.07 |
| Soybean- | 120° C., 15 Sec | 3.96 | 4.01 | 3.85 | 3.93 | 4.05 |
| Product- | 120° C., 30 Sec | 3.90 | 4.07 | 3.82 | 3.89 | 3.92 |
| based Sauce | 125° C., 15 Sec | 3.85 | 3.92 | 3.54 | 3.72 | 3.63 |

(5-point scale method, n = 10, preference)

As a result of confirming the sensory qualities of the hot pepper paste, soybean paste, seasoned soybean paste, and a fermented-soybean-product-based sauce manufactured by the method of the present disclosure, according to the conditions of the direct steam injection sterilization method, the following products showed a high preference with respect to overall taste: hot pepper paste (sterilized at 120° C., 15 sec); soybean paste (sterilized at 120° C. to 125° C., 30 sec).

### Experimental Example 8 Results of Sensory Evaluation of Fermented Soybean Products Manufactured by the Method of the Present Disclosure (2)

To compare the sensory qualities of the hot pepper paste, soybean paste, seasoned soybean paste, and a fermented-soybean-product-based sauce, which were evaluated to have excellent sensory properties in Experimental Example 7, with the products which were manufactured by batch and retort methods, 10 professional panelists were allowed to taste these products and a sensory test was performed by using a 5-point scale method to obtain the mean values. The results are shown in Table 9 below.

TABLE 9
Results of sensory evaluation of fermented soybean products
manufactured by the method of the present disclosure

| | Conditions | | | | | |
|---|---|---|---|---|---|---|
| | for Direct | | | | | |
| | Steam | Over- | | | | Steril- |
| Group of | Injection | all | | | | ization |
| Products | Sterilization | Taste | Color | Flavor | Taste | Odor |
| Hot Pepper | Batch | 3.79 | 3.91 | 3.95 | 3.75 | 3.86 |
| Paste | (65° C., 15 Min) | | | | | |
| | Retort | 3.63 | 3.66 | 3.50 | 3.63 | 3.38 |
| | (121° C., 5 Min) | | | | | |
| | DSI | 3.81 | 3.94 | 3.92 | 3.79 | 3.85 |
| | (120° C., 15 Sec) | | | | | |
| Soybean | Batch | 3.62 | 3.51 | 3.33 | 3.64 | 3.57 |
| Paste | (75° C., 20 Min) | | | | | |
| | Retort | 3.54 | 3.47 | 3.21 | 3.57 | 3.29 |
| | (121° C., 5 Min) | | | | | |
| | DSI | 3.69 | 3.50 | 3.37 | 3.72 | 3.55 |
| | (120° C., 30 Sec) | | | | | |
| Seasoned | Batch | 3.85 | 3.52 | 3.91 | 3.94 | 3.86 |
| soybean | (72° C., 20 Min) | | | | | |
| paste | Retort | 3.75 | 3.55 | 3.65 | 3.78 | 3.54 |
| | (121° C., 5 Min) | | | | | |
| | DSI | 3.88 | 3.74 | 3.90 | 3.93 | 3.84 |
| | (120° C., 15 Sec) | | | | | |
| Fermented- | Batch | 3.79 | 3.65 | 3.78 | 3.81 | 3.59 |
| Soybean- | (85° C., 20 Min) | | | | | |
| Product- | Retort | 3.62 | 3.58 | 3.55 | 3.66 | 3.48 |
| based Sauce | (121° C., 5 Min) | | | | | |
| | DSI | 3.86 | 3.79 | 3.85 | 3.84 | 3.71 |
| | (120° C., 15 Sec) | | | | | |

(5-point scale method, n = 10, preference)

The sensory qualities of the hot pepper paste, soybean paste, seasoned soybean paste, fermented-soybean-product-based sauce manufactured by the method of the present disclosure were confirmed to be equivalent or greater compared to those manufactured by the batch sterilization method. Additionally, it was confirmed that the hot pepper paste, soybean paste, seasoned soybean paste, fermented-soybean-product-based sauce manufactured by the method of the present disclosure have significantly excellent preferences for the sterilization odor (e.g., starch syrup odor, etc.) compared to those subjected to heat treatment at 121° C. for 5 minutes by the retort method, thus confirming that the improved taste quality by minimizing thermal impact due to the use of a direct steam injection method.

1. A method of manufacturing a composition of fermented soybean products, comprising:
preheating a raw material of fermented soybean products;
sterilizing the raw material using steam as a heating medium; and
cooling, filling, and packing the sterilized raw material.

2. The method of claim 1, wherein the raw material of the fermented soybean product comprises at least one kind selected from hot pepper paste, soybean paste, and seasoned soybean paste.

3. The method of claim 1, further comprising adding 1-50 parts by weight of water to the raw material.

4. The method of claim 1, further comprising chopping the raw material to which water is added.

5. The method of claim 1, wherein the preheating is performed by heating the raw material of fermented soybean products at 45° C. to 85° C.

6. The method of claim 1, wherein the sterilization is performed at 105° C. to 135° C. for 5-40 seconds.

7. The method of claim 1, wherein the sterilized raw material has the total number of bacteria of 105 CFU/g or less.

8. The method of claim 1, wherein the cooling is to reduce the sterilized raw material to 15° C. to 35° C. under reduced pressure.

9. A composition of fermented soybean products manufactured by the manufacturing method of claim 1.

10. A composition of fermented soybean products manufactured by the manufacturing method of claim 2.

11. A composition of fermented soybean products manufactured by the manufacturing method of claim 3.

12. A composition of fermented soybean products manufactured by the manufacturing method of claim 4.

13. A composition of fermented soybean products manufactured by the manufacturing method of claim 5.

14. A composition of fermented soybean products manufactured by the manufacturing method of claim 6.

15. A composition of fermented soybean products manufactured by the manufacturing method of claim 7.

16. A composition of fermented soybean products manufactured by the manufacturing method of claim 8.
